(19) United States
(12) Patent Application Publication
(10) Pub. No.: US 2023/0399255 A1
(43) Pub. Date: Dec. 14, 2023

(54) ENAMEL PASTE COMPOSITIONS, ENAMEL COATED PRODUCTS, AND METHODS OF MANUFACTURING THE SAME

(71) Applicant: FENZI AGT NETHERLANDS B.V., Maastricht (NL)

(72) Inventors: Simon BARTOLOMEY, Maastricht (NL); Jonathan BOOTH, Reading Berkshire (GB); Patricia Ann SUTTON, Reading Berkshire (GB)

(21) Appl. No.: 18/032,316

(22) PCT Filed: Sep. 20, 2021
(86) PCT No.: PCT/EP2021/075797

§ 371 Date: Apr. 17, 2023

(30) Foreign Application Priority Data
Oct. 16, 2020 (GB) 2016443.0

(51) Int. Cl. C03C 8/22; C03C 8/16; C03C 8/04; C03C 17/04

(52) U.S. Cl. CPC C03C 8/22; C03C 8/16; C03C 8/04; C03C 17/04; C03C 2207/00; C03C 2217/452; C03C 2217/475

(57) ABSTRACT

An enamel paste composition includes glass frit; a pigment; and an organic carrier medium; wherein the glass frit includes at least two glass frits including a first glass frit and a second glass frit, and wherein the first glass frit has a larger particle size and a higher glass transition temperature than the second glass frit. Also described is a method of forming an enamel coating by depositing the enamel paste composition on a substrate; and firing the enamel paste to form an enamel coating on the substrate, the enamel coating having a heterogeneous frit microstructure with particles of the first frit embedded in a matrix of second frit.

### FIELD

The present specification relates to enamel paste compositions, enamel coated products, and methods of manufacturing the same.

### BACKGROUND

In the automotive glazing industry, it is common to decorate windshields, back and side lights, and other glass components with a black band of obscuration enamel extending around a peripheral region of the components. A primary function is to shield the glue that holds the glass components in place from ultraviolet radiation which would otherwise decompose the glue. A secondary function is to cover up electrical circuits, wires, and connectors that ensure functionality of electrical or electronic components attached to, or embedded into, the glass component and ensure a clean aesthetic appearance.

Enamels are applied as a paste or ink in a screen printing or ink jet process to a flat glass substrate and are subsequently fired at high temperatures, during which the organic carrier medium of the paste or ink burns off and the enamel fuses together and establishes a bond to the substrate. The firing process softens the substrate which can be formed into the final shape by a bending process.

A commercial drive of the automotive industry is towards lower process temperatures and the use of thinner substrates for automotive glazing in order to save fuel and reduce greenhouse gas emissions by reducing weight of automotive vehicles while simultaneously not giving up on product performances that have already been achieved with conventional enamels fired at higher temperatures. There is also a need to reduce optical distortions in certain areas of the final glass component where sensors and cameras may be attached that are required for advanced driver-assistance systems (ADAS) and autonomous driving vehicles.

The automotive obscuration enamels are multicomponent composites comprising one or more glass frits, pigments, and inorganic functional additives. The component particles are finely milled so that they can pass through a printing screen or an ink jet nozzle without blocking during printing. Conventional paste compositions which comprise two or more different glass frits generally have a comparable particle size distribution for the different glass frits. The different frit types are also conventionally selected to fuse together mutually at processing temperatures in excess of the glass transition temperature and fusing temperature of all the frits to form an enamel with a homogeneous micro-structure in terms of frit particle size distributions. In this regard, it will be understood that a conventional enamel is still heterogeneous having distinct frit regions with pigment and seed additive dispersed through the enamel layer. However, the frit regions themselves have a homogeneous microstructure.

The industry is now pushing towards lower process temperatures and increased throughput as thinner glass components are used to reduce the weight of the component and to reduce energy consumption in the firing process before bending. With conventional enamels this is difficult to achieve. Lower glass transition temperature frits have been developed but they tend to yield enamels which do not have the same functional performance characteristics of current higher glass transition temperature frits.

There is thus a need to provide enamel paste compositions which yield an enamel that fuses at lower temperatures while still maintaining desirable bulk properties such as acid durability, coefficient of thermal expansion (CTE) match to substrates, and good mechanical and optical properties that are typically attributed to high fusing temperature frits.

It is an aim of the present specification to address one or more of the aforementioned problems and to provide enamel paste compositions which fuse at low temperatures while achieving functional properties associated with a higher fusing temperature enamel.

### SUMMARY

According to an aspect of the present specification there is provided an enamel paste composition comprising:
glass frit;
a pigment; and
an organic carrier medium;
wherein the glass frit comprises at least two glass frits including a first glass frit and a second glass frit, and
wherein the first glass frit has a larger particle size and a higher glass transition temperature than the second glass frit.

When such a paste is deposited and fired, the second lower glass transition temperature frit is sintered around the larger particles of the first higher glass transition temperature frit. The enamel micro-structure after firing is reminiscent of a bricks-and-mortar structure with the first glass frit forming the “bricks” and the second glass frit having been sintered to form the “mortar”. The microstructure of the enamel can be controlled by appropriate selection of the two (or more) frits and their respective particle size distributions, volume fractions, and the temperature at which the paste is fired, e.g. which may be at a firing temperature between the glass transition temperatures of the glass frits in the paste composition.

A characteristic of the multi-frit paste systems of the present specification is that the frits do not fuse into homogeneous frit regions within the enamel coating on firing but rather provide a coherent heterogeneous frit micro-structure comprising two entangled, percolating 3-dimensional (3D) networks of larger functional particles of the first frit (“bricks”) and fine milled particles of the second frit (“mortar”). The second lower glass transition temperature frit is mainly responsible for the cohesion of the enamel, adhesion to the substrate, and to act as an embedding matrix for functional additives such as pigments and seed materials. The first higher glass transition temperature frit can be selected to modify the functional properties of the composite material according to end use specifications without the limitation of being required to have a low glass transition temperature. That is, the relative quantities and types of first and second frit can be tailored for a range of macroscopic properties including one or more of increased acid durability, improved CTE match with substrate, reduced glass weakening, increased enamel strength, improved silver hiding, and reduced optical (focal line) distortions in undecorated parts of the final piece, e.g. in openings for sensors or cameras. Furthermore, it has been found that these functional performance characteristics are more readily achieved at lower firing temperatures using a heterogeneous “bricks-and-mortar” frit micro-structure compared with conventional enamel coatings which have homogeneous frit regions in terms of frit particle size distributions. The performance characteristics of the heterogenous frit micro-structure can be at least partially due to a combination of the characteristics of the individual frits used to form the heterogeneous enamel structure. However, certain performance characteristics can also be enhanced due to reactions occurring between the different frits in situ which leads to performance characteristics in the composite material beyond the mere combination of characteristics of the individual frits taken alone. Further still, it should be emphasized that the particle size difference between the frits is a critical feature to achieve the observed performance improvements. Comparative studies have shown that a paste composition which comprises a comparable mixture of frit types, but with a homogenous frit particle size distribution, requires significantly higher firing temperatures to achieve the required performance characteristics for end applications (e.g. acid durability, opacity, etc.) compared with the bricks-and-mortar frit micro-structure of the present specification in which the higher glass transition temperature frit has a larger particle size than the lower glass transition temperature frit. The performance improvements when using frits of a different size distribution can be partially attributable to a change in performance characteristics of the individual frits when their particle size is changed, but can also be partially attributable to an enhancement in the reactions occurring between the different frits in situ due to the change in particle size distributions of the component frits.

Accordingly, this specification addresses the commercial drive of the automotive industry towards lower process temperatures and the use of thinner substrates for automotive glazing in order to save fuel and reduce greenhouse gas emissions by reducing weight of the automotive vehicle while retaining performance characteristics which have already been achieved with conventional enamels fired at higher temperatures. The pastes and enamels described herein also aid in reducing optical distortions where sensors and cameras may be attached for advanced driver-assistance systems (ADAS) and autonomous driving vehicles.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic illustration of a bricks-and-mortar enamel structure; and

FIG. 2 shows an actual back-scattered electron (BSE) image of a cross-section sample of a bricks-and-mortar enamel structure.

### DETAILED DESCRIPTION

The present specification provides new automotive silver hiding enamels with a “bricks-and-mortar” micro-structure for press bending applications. The specifically engineered morphology yields an enamel that fuses at lower temperatures (following market trend) while still maintaining bulk properties that are typically attributed to high fusing frits including acid durability, CTE matching to substrate, mechanical properties, etc.

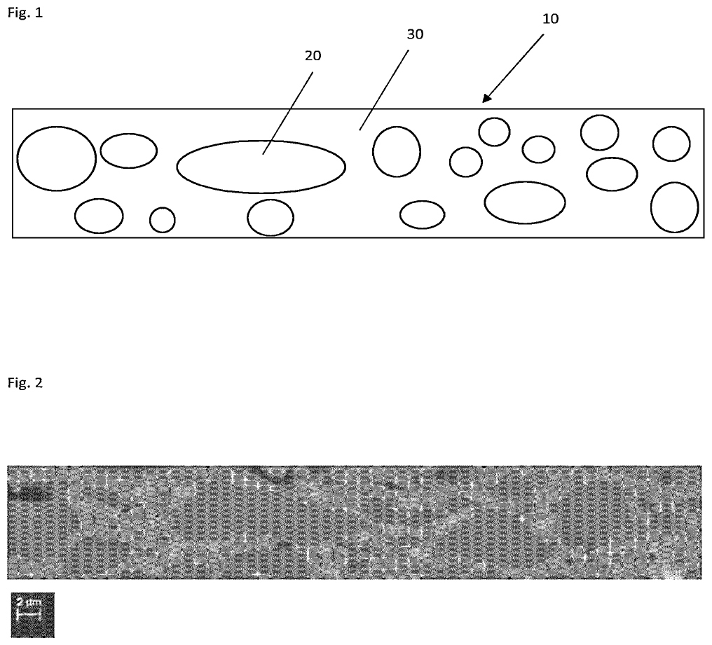

FIG. 1 shows a schematic illustration of a bricks-and-mortar enamel structure 10 comprising large “brick” particles 20 embedded in a “mortar” matrix 30. FIG. 2 shows an actual back-scattered electron (BSE) image of a cross-section sample of a bricks-and-mortar enamel structure.

The morphology is achieved by an appropriate selection of at least two functional frits and their respective particle size distributions, where the higher fusing temperature frit is coarser, and the lower fusing temperature frit is much finer. The resultant paste or ink may be applied by any paste or ink deposition technique, provided the respective particle size ratios support a bricks-and-mortar structure in the final enamel. Such processes may comprise, for example, screen printing and ink jet printing.

As described in the summary section, the enamel paste compositions according to the present specification comprise:
glass frit;
a pigment; and
an organic carrier medium;
wherein the glass frit comprises at least two glass frits including a first glass frit and a second glass frit, and
wherein the first glass frit has a larger particle size and a higher glass transition temperature than the second glass frit.

The first and second frits can be selected according to a target firing temperature in the end application. During firing the second glass frit is required to soften and sinter to form a matrix which binds the particles of the first frit and bonds the enamel coating to an underlying substrate forming a heterogenous bricks-and-mortar micro-structure. The first glass frit may, for example, have a glass transition temperature of: at least 465° C., 470° C., 475° C., 480° C., or 485° C.; and/or no more than 550° C., 530° C., 515° C., or 500° C.; and/or within a range defined by any combination of the aforementioned lower and upper limits. For example, the first glass frit may have a glass transition temperature in a range 470-515° C., optionally 485-500° C. Furthermore, the second glass frit may, for example, have a glass transition temperature of: at least 410° C., 420° C., 430° C., or 440° C.; and/or no more than 460° C., 455° C., or 450° C.; and/or within a range defined by any combination of the aforementioned lower and upper limits. For example, the second glass frit may have a glass transition temperature in a range of 430-455° C., optionally 440-450° C.

In addition to selecting the frits according to their glass transition temperature parameter, the frits are processed such that the first (higher fusing) frit has a larger particle size than the second (lower fusing) frit to achieve a bricks-and-mortar micro-structure after firing. The specific particle sizes for the frits may vary according to the target micro-structure.

The first glass frit may have a particle size meeting one or more of the following characteristics:
a D90: of at least 6 μm, 7 μm, 8 μm, 8.5 μm, or 8.8 μm; no more than 20 μm, 15 μm, 13 μm, 12.5 μm, or 11.8 μm; or within a range defined by any combination of the aforementioned lower and upper limits;
a D50: of at least 1.5 μm, 1.6 μm, 1.7 μm, 1.8 μm, or 1.9 μm; no more than 5 μm, 4 μm, 3.8 μm, or 3.6 μm; or within a range defined by any combination of the aforementioned lower and upper limits;
a maximum particle size of no more than 40 μm, 35 μm, 30 μm, or 26 μm.

Furthermore, the second glass frit may have a particle size meeting one or more of the following characteristics:
a D90: of at least 0.5 μm, 0.8 μm, 1.0 μm, or 1.2 μm; no more than 4 μm, 3 μm, 2.2 μm, or 1.9 μm; or within a range defined by any combination of the aforementioned lower and upper limits;
a D50: of at least 0.1 μm, 0.2 μm, 0.3 μm, 0.4 μm, or 0.5 μm; no more than 1.4 μm, 1.3 μm, 1.2 μm, or 1.0 μm; or within a range defined by any combination of the aforementioned lower and upper limits;
a maximum particle size of no more than 10 μm, 9 μm, 8 μm, 7 μm, or 6 μm.

For example, the first frit may have: a D90 particle size in a range 8.5-12.5 μm, preferably 8.8-11.8 μm; a D50 particle size in a range 1.8-3.8 μm, preferably 1.9-3.6 μm; and a maximum particle size typically below 26 μm. The second frit may have a D90 particle size in a range 1.2-2.2 μm, preferably 1.2-1.9 μm; a D50 particle size in a range 0.5-1.2 μm, preferably 0.5-1.0 μm; and a maximum particle size typically below 6 μm.

The frits are milled to the desired particle sizes in a suitable process that may comprise for example jet milling, dry or wet ball or bead milling, or a combination thereof. The medium used for wet milling processes may comprise water, alcohols, glycols, and may be mixed with a suitable addition of a dispersing agent. Wet milled powders are submitted to a suitable drying process, e.g. flame spray drying or tray drying, or are incorporated as a slurry in the final product (paste or ink) formulation. The particle size distributions are determined by a laser diffraction method and yield volume equivalent sphere diameters. These are expressed as D values, e.g. D10, D50, D90, D99, and the maximum particle size.

In practice the midpoint D50 and the high end of the distribution D90 are deemed process relevant parameters and are determined for a wet sample/slurry. In one application, the higher fusing frit 1 has a D90=12±1 μm and a D50=3.4±0.2 μm, while the lower fusing frit has a D90<2 μm and a D50=0.75±0.2 μm. The relative sizes of the frits to one another are such that D90 of the higher fusing frit can be at least 5× larger in diameter than that of the lower fusing frit, and that D50 of the higher fusing frit can be at least 4× larger than that of the lower fusing frit.

For frit materials that are post-processed after milling and/or dried, the particle size distributions may vary from that of the slurry due to the formation of more or less soft agglomerates. These agglomerates break and disperse during the production of the final product.

According to certain examples, the first (higher fusing) glass frit forms a larger volume fraction and/or larger weight fraction of the glass frit than the second (lower fusing) glass frit. This may be desirable when it is required that the functional parameters of the first glass frit dominate the functional properties of the composite enamel after firing. For example, if a sulphided zinc silicate glass is used as the first frit, this gives excellent silver hiding properties to this enamel system as the reduced zinc glass reacts with silver ions that migrate through the enamel layer. In this instance, the silver from underlying conductive tracks does not migrate that far if a high content of the sulphided zinc silicate glass is provided in the composition which is very beneficial as otherwise silver migration through the enamel towards the surface of the substrate leads to an unwanted brown or yellow discoloration.

That said, in certain arrangements it may be desirable for the second (lower fusing temperature) glass frit to form a substantial proportion of the frit. This may be the case, for example, if the first frit has an undesirable characteristic such as low acid durability. In this case, it may be required to provide a sufficient amount of the second frit to protect the first frit from acid attack. Furthermore, it has been found that acid durability of the “mortar” phase of the enamel formed by the second glass frit when fired at low temperatures is improved using a more finely milled second glass frit (e.g. bead milled) compared to a standard milled frit.

Further still, if the first (higher fusing temperature) frit making up the bricks is in a reduced state, and the second (lower fusing temperature) frit making up the mortar is in an oxidized state, the redox interaction between bricks and mortar particles can result in the precipitation of bismuth nanoparticles and a depletion of Bi₂O₃ from the mortar, which in turn leads to an increase of relative silica content thus further improving acid durability of the mortar. In addition, the aggregate nature of the mortar formed by the second frit and incorporating fine pigment particles is also beneficial to acid durability as the pigment is very acid resistant.

As such, it will be appreciated that functional performance characteristics such as acid durability can result from a complex number of factors in the composite material. Further still, factors affecting one functional performance characteristic can also affect other functional performance characteristics. For example, the precipitation of bismuth nanoparticles which has a role in improving acid durability of the mortar phase of the enamel as previously discussed can also play a role in improving opacity. It has also been postulated that the precipitation of bismuth nanoparticles could also contribute to inhibiting silver migration, although in certain examples described herein this functionality is largely provided by the selection of a suitable first high fusing temperature frit such as a zinc-silicate frit as previously described. It will therefore be further appreciated that both the brick and mortar phases can contribute to provide an advantageous combination of functional properties for the enamels of the present specification.

In light of the above, it will be appreciated that the type and amount of first and second glass frits can be tailored for a particular combination of desired functional performance characteristics. According to certain examples, the first glass frit forms a volume fraction of the glass frit of: at least 0.45, 0.50, or 0.60; and/or no more than 0.90, 0.87, 0.81, or 0.80; and/or within a range defined by any combination of the aforementioned lower and upper limits. Similarly, the second glass frit may form a volume fraction of the glass frit of: at least 0.1, 0.13, 0.16, 0.19, or 0.2; and/or no more than 0.55, 0.45, or 0.40; and/or within a range defined by any combination of the aforementioned lower and upper limits. In terms of volume ratio, a volume ratio of the first glass frit to second glass frit may be: at least 0.8, 1.0, 1.2, 1.5, or 2; and/or no more than 6.7, 5.0, 4.4, or 4.0; and/or within a range defined by any combination of the aforementioned lower and upper limits.

Alternatively, expressed in terms of weight rather than volume, the first glass frit may form a weight fraction of the glass frit: of at least 0.35, 0.45, 0.55, or 0.60; and/or no more than 0.90, 0.85, 0.80, or and/or within a range defined by any combination of the aforementioned lower and upper limits. Additionally, the second glass frit may form a weight fraction of the glass frit: of at least 0.1, 0.15, 0.20, or 0.25; and/or no more than 0.55, 0.50, 0.45, or 0.40; and/or within a range defined by any combination of the aforementioned lower and upper limits. Further still, a weight ratio of the first glass frit to second glass frit may be: at least 0.8, 0.9, 1.0, 1.2, 1.5, or 2; and/or no more than 5.0, 4.5, 4.0, 3.5, or 3; and/or within a range defined by any combination of the aforementioned lower and upper limits.

The aforementioned numerical ranges are reflected in the range of examples provided later in this specification and are indicative that while in many preferred examples the amount of first frit is larger than the amount of second frit in the paste compositions and resultant enamels of the present specification, this is not a strict requirement for all applications. There must be at least sufficient quantities of the second frit to fuse and form the mortar phase of the enamel binding together the larger particles of the first frit and providing adherence to the underlying substrate on which the enamel is disposed. The amount of second frit which is desirable over and above this lower mechanical constructional limit will be dependent on target functional properties and the types of frit which are utilized. An optimal ratio of first and second frit for a particular application can be tuned by experimental optimization following the teachings of this specification.

With regard to chemical composition of the frits, the first glass frit may be selected from the group consisting of a bismuth-silicate, a zinc-silicate, and a bismuth-zinc-silicate. For example, a reduced zinc-silicate glass reacts with silver ions that migrate through the enamel layer. In this instance, the silver does not migrate that far if a high content of the reduced zinc silicate glass is provided in the composition which is very beneficial for silver hiding.

The second glass frit may also be a bismuth-silicate and advantageously contains less silica and more bismuth and/or boron than the first glass frit as it is tailored to have a lower glass transition temperature compared to higher silica content silicate glasses. Such lower silica content, lower fusing temperature glass can be susceptible to acid degradation in end applications. However, as previously indicated, redox interactions between the first and second glass frits can result in an increase of relative silica content in the mortar phase formed by the second glass frit thus improving acid durability of the mortar phase in situ compared to the acid durability of the second glass frit material alone. The critical requirement for the automotive industry is durability after 72 hours exposure to 0.1N H₂SO₄ at 80° C., which has been achieved at significantly lower firing temperatures using the paste compositions of the present specification. Further still, the bricks-and-mortar structure has also been found to have better silver hiding properties at low firing temperatures as its capacity to inhibit the migration of silver through the enamel is much higher.

In addition to the glass frit components, the composition may also include other additives, e.g. a seed additive, as is known in the art to tune properties of glass materials. The weight ratio of the frit components can be practically limited by the amount of functional additives, e.g. seed materials and pigments, that need to be embedded in the mortar phase which acts as an embedding matrix for functional additives. The respective amounts of functional additives depend on customer requirements and their process parameters and may vary according to their firing and bending process. This variation also affects the weight ratios of the frits and other components of the enamel paste. For example, the weight and/or volume ratio of the high fusing temperature frit to the low fusing temperature frit may be >1 to 4.

The aforementioned paste composition is designed to be used in a method of forming an enamel coating comprising: depositing the enamel paste composition on a substrate; and firing the enamel paste to form an enamel coating on the substrate, the enamel coating comprising a heterogeneous frit microstructure with particles of the first frit embedded in a matrix of second frit. Optionally, the enamel paste may be fired at a temperature lower than a fusing temperature of the first glass frit but higher than a fusing temperature of the second glass frit.

Using the aforementioned method, an enamel coated substrate can be produced in which bulk enamel properties that are typically attributed to frits fusing at high temperatures can be achieved and optimized at much lower firing temperatures. These properties comprise silver hiding, acid durability, mechanical properties, and CTE.

Providing a significant proportion of the enamel as larger, coarser particles of the first frit also has the advantage of being easier and cheaper to fabricate than a composition based only on finer particles which require more processing. The high fusing temperature frit(s) may be rich in silica and comprise, for example, bismuth-silicates, zinc-silicates, and/or bismuth-zinc-silicates depending on the desired function and firing window. For such frits, raw materials and processing can be made cost-effective using the present approach in which larger particles of the materials can be utilized. In contrast, the low fusing temperature frit(s) acts as a mortar for the higher fusing temperature frit(s), provides an embedding matrix for functional additives, and is responsible for the cohesion of all frit particles. To support this function, the low fusing temperature frit is milled down to much finer particle sizes in comparison to the coarse particles of the higher fusing temperature frit. The low fusing temperature frit may typically contain less silica and often significant amounts of bismuth or boron or other oxides that promote low fusing temperature, depending on the desired function and firing window. The bismuth containing frit has a high density and is relatively soft, so it is, in comparison to zinc-silicate frits, easier and cheaper to mill down to smaller particle sizes. The bismuth-silicate frit cost depends on price fluctuations of the raw materials and it may be of strategic importance to keep amounts as low as possible. The amount of Bi₂O₃ in the paste formulations of the present specification can be, for example, as low as 6-15 wt %. As such, it will be appreciated that the present approach can provide significant cost savings both in terms of the raw materials and in terms of their processing costs.

It has been found that by using a tailored enamel morphology as described herein, all major requirements of the automotive glazing industry can be met at reduced temperature process conditions. The CTE of the final enamel can also be made to better match the substrate, thus reducing or mitigating optical (focal line) distortion in undecorated areas where there is an opening for sensors and cameras. Further still, the coherence of the enamel is good while glass weakening of the substrate is minimized. The advantages of an enamel designed in this way in comparison to conventional enamels are a lower fusing temperature, much improved acid durability, reduced shrinkage during fusion and thus less stresses. Furthermore, the silver hiding range is increased and stretched to higher firing temperatures as silver migration is significantly slowed.

This specification thus addresses multiple trends in the automotive glazing market. One such driver is the need for thinner glass substrates in order to save weight and thus make the automotive more energy efficient. Lower glass thicknesses require a reduction of process temperatures in order to achieve the final shape. Another driver is the industry implementing more and more external press bending processes that operate at low temperatures and a high throughput while achieving the best results in terms of shape geometry and optical distortion levels. For the external press bending application, a tailor-made enamel according to the present specification is suitable for a low temperature firing range while not giving up on any of the product properties that are considered standard in other applications. Embodiments can be specifically designed to address the increasingly demanding requirements of the automotive market striving towards autonomous driving, where multiple and complex decorations of black and silver enamel on a windshield need to be applied to support wiring and attachment of sensors and cameras. The specific tailoring of enamel morphology to serve a certain purpose can also be expanded to other applications. It also offers the opportunity to reduce expensive raw materials and replace them with cheaper materials.

### Examples

Paste compositions were prepared by mixing glass frit, pigment, seed, and organic carrier medium components together to produce a range of paste formulations as summarized in the table below.

| | | | | | | | | | |
|---|---|---|---|---|---|---|---|---|---|
| Sample | A | B | C | D | E | F | G | H | I |

Inorganic Composition wt %

| | | | | | | | | | |
|---|---|---|---|---|---|---|---|---|---|
| Frit 1 “Bricks” | 41.72 | 45.82 | 48.94 | 51.39 | 53.36 | 54.97 | 36.32 | 28.05 | 15.07 |
| Frit 2 “Mortar” | 33.03 | 28.59 | 25.20 | 22.52 | 20.35 | 18.55 | 39.34 | 48.08 | 61.81 |
| Functional Additives | 3.79 | 4.15 | 4.45 | 4.70 | 4.93 | 5.14 | 2.70 | 2.23 | 1.49 |
| “Seeds” | | | | | | | | | |
| Functional Additives | 21.47 | 21.44 | 21.42 | 21.39 | 21.37 | 21.34 | 21.64 | 21.64 | 21.63 |
| “Pigments” | | | | | | | | | |

Frit weight fraction relative to total frit amount

| | | | | | | | | | |
|---|---|---|---|---|---|---|---|---|---|
| Weight Fraction | 0.56 | 0.62 | 0.66 | 0.70 | 0.72 | 0.75 | 0.48 | 0.37 | 0.20 |
| Frit 1 | | | | | | | | | |
| Weight Fraction | 0.44 | 0.38 | 0.34 | 0.30 | 0.28 | 0.25 | 0.52 | 0.63 | 0.80 |
| Frit 2 | | | | | | | | | |
| Weight Ratio | 1.26 | 1.60 | 1.94 | 2.28 | 2.62 | 2.96 | 0.92 | 0.58 | 0.24 |
| Frit 1:Frit 2 | | | | | | | | | |

Frit volume fraction relative to total frit volume

| | | | | | | | | | |
|---|---|---|---|---|---|---|---|---|---|
| Volume Fraction | 0.65 | 0.70 | 0.74 | 0.77 | 0.79 | 0.81 | 0.58 | 0.46 | 0.26 |
| Frit 1 | | | | | | | | | |
| Volume Fraction | 0.35 | 0.30 | 0.26 | 0.23 | 0.21 | 0.19 | 0.42 | 0.54 | 0.74 |
| Frit 2 | | | | | | | | | |
| Volume Ratio | 1.85 | 2.35 | 2.85 | 3.35 | 3.85 | 4.34 | 1.35 | 0.86 | 0.36 |
| Frit 1:Frit 2 | | | | | | | | | |

In the aforementioned examples, Frit 1 is a sulphided zinc silicate glass and Frit 2 is a bismuth silicate glass which has a lower silica content and a lower glass transition temperature than Frit 1. Particle sizes for Frit 1 and Frit 2 fall within the ranges previously specified with the particle size for Frit 1 being significantly larger than that of Frit 2 in terms of D50, D90, and maximum particle size parameters. The paste formulations were deposited on glass substrates and fired to yield enamel coatings having a bricks-and-mortar frit morphology as illustrated, for example, in FIG. 2.

Functional performance characteristics of the enamels have been tested. Results indicate that enamels of the present specification having a bricks-and-mortar heterogeneous frit micro-structure meet the required performance values for end use (opacity, acid durability, etc.) at significantly lower firing temperatures compared with compositions which contain the same two frit types but with a homogenous frit micro-structure in terms of frit particle size distribution. For example, in comparative studies where embodiments of the invention were tested against a benchmark paste, the required acid durability for the resultant enamel was achieved at firing temperatures that were at least 10° C. and, for certain examples, more than 25° C. lower. In the comparative studies, the benchmark paste contained the same frit types as the examples, but with a homogenous particle size distribution. As such, the improvement in performance was attributable to the change in micro-structure of the frit phase of the enamel in which the first (higher glass transition temperature) frit had a larger particle size than the second (lower glass transition temperature) frit forming a bricks-and-mortar frit micro-structure as described herein.

While this invention has been particularly shown and described with reference to certain examples, it will be understood to those skilled in the art that various changes in form and detail may be made without departing from the scope of the invention as defined by the appended claims.

1: An enamel paste composition comprising:
glass frit;
a pigment; and
an organic carrier medium;
wherein the glass frit comprises at least two glass frits including a first glass frit and a second glass frit, and
wherein the first glass frit has a larger particle size and a higher glass transition temperature than the second glass frit.

2: The enamel paste composition according to claim 1,
wherein the first glass frit has a glass transition temperature of: at least 465° C., 470° C., 475° C., 480° C., or 485° C.; no more than 550° C., 530° C., 515° C., or 500° C.; or within a range defined by any combination of the aforementioned lower and upper limits.

3: The enamel paste composition according to claim 1,
wherein the second glass frit has a glass transition temperature of: at least 410° C., 420° C., 430° C., or 440° C.; no more than 460° C., 455° C., or 450° C.; or within a range defined by any combination of the aforementioned lower and upper limits.

4: The enamel paste composition according to claim 1,
wherein the first glass frit has a particle size meeting one or more of the following characteristics:
a D90: of at least 6 μm, 7 μm, 8 μm, 8.5 μm, or 8.8 μm; no more than 20 μm, 15 μm, 13 μm, 12.5 μm, or 11.8 μm; or within a range defined by any combination of the aforementioned lower and upper limits;
a D50: of at least 1.5 μm, 1.6 μm, 1.7 μm, 1.8 μm, or 1.9 μm; no more than 5 μm, 4 μm, 3.8 μm, or 3.6 μm; or within a range defined by any combination of the aforementioned lower and upper limits;
a maximum particle size of no more than 40 μm, 35 μm, 30 μm, or 26 μm.

5: The enamel paste composition according to claim 1,
wherein the second glass frit has a particle size meeting one or more of the following characteristics:
a D90: of at least 0.5 μm, 0.8 μm, 1.0 μm, or 1.2 μm; no more than 4 μm, 3 μm, 2.2 μm, or 1.9 μm; or within a range defined by any combination of the aforementioned lower and upper limits;
a D50: of at least 0.1 μm, 0.2 μm, 0.3 μm, 0.4 μm, or 0.5 μm; no more than 1.4 μm, 1.3 μm, 1.2 μm, or 1.0 μm; or within a range defined by any combination of the aforementioned lower and upper limits;
a maximum particle size of no more than 10 μm, 9 μm, 8 μm, 7 μm, or 6 μm.

6: The enamel paste composition according to claim 1,
wherein the first glass frit forms a volume fraction of the glass frit of: at least 0.45, 0.50, or 0.60; no more than 0.90, 0.87, 0.81, or 0.80; or within a range defined by any combination of the aforementioned lower and upper limits.

7: The enamel paste composition according to claim 1,
wherein the second glass frit forms a volume fraction of the glass frit of: at least 0.1, 0.13, 0.19, or 0.2; no more than 0.55, 0.50, 0.45, or 0.40; or within a range defined by any combination of the aforementioned lower and upper limits.

8: The enamel paste composition according to claim 1,
wherein the first glass frit forms a weight fraction of the glass frit of: at least 0.35, 0.45, or 0.60; no more than 0.90, 0.85, 0.80, or 0.75; or within a range defined by any combination of the aforementioned lower and upper limits.

9: The enamel paste composition according to claim 1,
wherein the second glass frit forms a weight fraction of the glass frit of: at least 0.1, 0.15, or 0.25; no more than 0.55, 0.50, 0.45, or 0.40; or within a range defined by any combination of the aforementioned lower and upper limits.

10: The enamel paste composition according to claim 1,
wherein a weight ratio of the first glass frit to second glass frit is: at least 0.8, 0.9, 1.0, 1.2, 1.5, or 2; no more than 5.0, 4.5, 4.0, 3.5, or 3; or within a range defined by any combination of the aforementioned lower and upper limits.

11: The enamel paste composition according to claim 1,
wherein a volume ratio of the first glass frit to second glass frit is: at least 0.8, 1.0, 1.2, 1.5, or 2; no more than 6.7, 5.0, 4.4, or 4.0; or within a range defined by any combination of the aforementioned lower and upper limits.

12: The enamel paste composition according to claim 1,
wherein the first glass frit forms a larger volume fraction of the glass frit than the second glass frit.

13: The enamel paste composition according to claim 1,
wherein the first glass frit forms a larger weight fraction of the glass frit than the second glass frit.

14: The enamel paste composition according to claim 1,
wherein the first glass frit is selected from the group consisting of a bismuth-silicate, a zinc-silicate, and a bismuth-zinc-silicate.

15: The enamel paste composition according to claim 1,
wherein the second glass frit contains less silica than the first glass frit.

16: The enamel paste composition according to claim 1,
wherein the second glass frit contains more bismuth and/or boron than the first glass frit.

17: The enamel paste composition according to claim 1,
wherein the second glass frit is a bismuth-silicate.

18: The enamel paste composition according to claim 1,
wherein the first glass frit is in a reduced state and the second glass frit is in an oxidized state.

19: The enamel paste composition according to claim 1,
further comprising a seed additive.

20: A method of forming an enamel coating comprising:
depositing the enamel paste composition according to any preceding claim on a substrate; and
firing the enamel paste to form an enamel coating on the substrate, the enamel coating comprising a heterogeneous frit microstructure with particles of the first frit embedded in a matrix of second frit.

21: The method according to claim 20,
wherein the enamel paste is fired at a temperature lower than a fusing temperature of the first glass frit but higher than a fusing temperature of the second glass frit.

22: An enamel coated substrate manufactured by the method of claim 20.
